(19) United States
(12) Patent Application Publication
(10) Pub. No.: US 2007/0012207 A1
(43) Pub. Date: Jan. 18, 2007

(54) Printing press equipped with movable inking unit

(75) Inventors: Akihiko Takenouchi, Noda-shi (JP); Hiromitsu Numauchi, Noda-shi (JP); Akehiro Kusaka, Noda-shi (JP)

Correspondence Address: BIRCH STEWART KOLASCH & BIRCH, PO BOX 747, FALLS CHURCH, VA, 22040-0747, US

(73) Assignee: KOMORI CORPORATION

(21) Appl. No.: 11/485,303

(22) Filed: Jul. 13, 2006

(30) Foreign Application Priority Data
Jul. 15, 2005 (JP) 2005-206397

(51) Int. Cl. B41K 1/38

(52) U.S. Cl. 101/335

(57) ABSTRACT

A printing press includes, a printing unit; a motor for driving the printing unit; a first drive system for drivingly connecting a blanketed impression cylinder, etc. of the printing unit to the motor; a first frame cover for covering the first drive system; an inker movable to be capable of being thrown on and thrown off the printing unit; a second drive system for driving ink rollers of the inker; and a second frame cover for covering the second drive system, the printing press further includes a motor for driving the ink rollers of the inker via the second drive system, and wherein opposed surfaces of the first frame cover and the second frame cover are entirely closed.

### BACKGROUND OF THE INVENTION

1. Field of the Invention

This invention relates to a printing press equipped with a movable inking unit which is preferred for offset printing.

2. Description of the Related Art

In a printing press for printing securities, multicolor printing is generally performed by a plurality of plate cylinders arranged in a satellite configuration around a single blanket cylinder. In this type of printing press, the plurality of plate cylinders are disposed in a vertical direction, thus involving a complicated structure. To increase the efficiencies of operations such as plate replacement and cleaning, it is necessary to separate an inking unit, which supplies inks to the plate cylinders, from a printing unit, thereby ensuring a work space.

Conventionally, the inking unit has been driven from the printing unit via gears. Thus, as shown in FIGS. 8 and 9, for example, a plurality of gear engagement windows, which are provided in opposed surfaces of a frame cover 101 of a printing unit 100 (a drive system of the printing unit 100 is accommodated inside) and a frame cover 103 of an inking unit 102 (a drive system of the inking unit 102 is accommodated inside), are opened and closed with protective covers 104. That is, when the inking unit 102 is thrown on the printing unit 100 to make contact therewith, the protective covers 104 are automatically opened. When the inking unit 102 is thrown off the printing unit 100 to become out of contact, the protective covers 104 are automatically closed. By so doing, a lubricating oil is prevented from scattering (see Japanese Utility Model Application Laid-Open Nos. 1989-174129, 1989-174133, 1989-178943, and 1990-2130).

The above-described printing press, however, faces the problems that while the inking unit 102 is in contact with the printing unit 100, and a gear mechanism is rotated at a high speed under an oil shower to carry out printing, the lubricating oil adheres to the opened protective covers 104, and when the inking unit 102 is thrown off the printing unit 100, the adhering lubricating oil drips from the closed protective covers 104.

Moreover, the adjustment of gear engagement between the inking unit 102 and the printing unit 100 has to be made, with the inking unit 102 being in contact with the printing unit 100. This poses the problem that the adjusting operation is difficult, takes time, and burdens an operator. Furthermore, the gears of the inking unit 102 and the gears of the printing unit 100 repeat engagement and disengagement, thus posing the problem that the accuracy of their engagement is lost in a relatively short time because of wear.

The present invention has been proposed in light of the above-described circumstances and provides a printing press equipped with a movable inking unit which can prevent oil leakage of the printing unit and the inking unit and can maintain their machine accuracy satisfactorily for a long term.

### SUMMARY OF THE INVENTION

A first aspect of the present invention is a printing press equipped with a movable inking unit, comprising:

a printing unit;

a first drive source for driving the printing unit;

a first drive system for drivingly connecting cylinders of the printing unit to the first drive source;

a first cover for covering the first drive system;

the movable inking unit movable to be capable of being thrown on and thrown off the printing unit;

a second drive system for driving ink rollers of the movable inking unit; and

a second cover for covering the second drive system,

the printing press further comprising a second drive source for driving the ink rollers of the movable inking unit via the second drive system, and

wherein a surface of the first cover opposing the second cover is entirely closed, and a surface of the second cover opposing the first cover is entirely closed.

According to a second aspect of the present invention, the first drive source and the second drive source may be motors driven and controlled by a control device such that the speed of the cylinders of the printing unit and the speed of the ink rollers are equal to each other.

According to a third aspect of the present invention, the printing unit may be composed of a plate cylinder, and an opposed cylinder opposing the plate cylinder, and the printing press may further comprise a third drive source for driving the plate cylinder.

According to a fourth aspect of the present invention, the third drive source may be a motor driven and controlled by a control device such that the plate cylinder and the opposed cylinder are synchronized with each other.

According to a fifth aspect of the present invention, the opposed cylinder may have a gripper device for transporting a material to be printed, and when the gripper device holds the material to be printed, an outermost peripheral portion of the gripper device may be located inwardly, in the radial direction of the opposed cylinder, of an outer peripheral surface of the opposed cylinder.

According to a sixth aspect of the present invention, the printing unit may be composed of a plate cylinder, and an opposed cylinder opposing the plate cylinder, and a gear fixed to a shaft of the plate cylinder for rotationally driving the plate cylinder may be an anti-backlash gear.

According to a seventh aspect of the present invention, the anti-backlash gear may have a first gear fixed to the shaft of the plate cylinder, a second gear adjacent to the first gear to be relatively rotatable and having an identical number of teeth to the number of teeth of the first gear, and a plurality of elastic members arranged at equal intervals in a circumferential direction and having one end supported by the first gear and another end supported by the second gear.

According to the printing press equipped with the movable inking unit concerned with the present invention, the printing unit and the movable inking unit are independently driven, and the covers accommodating the respective drive systems have their opposed surfaces entirely closed. Thus, oil leakage can be prevented. Moreover, gear engagement between the drive systems does not take place. Thus, the machine accuracy of the printing unit and the inking unit can be maintained satisfactorily for a long term.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a printing press equipped with a movable inking unit, showing Embodiment 1 of the present invention;

FIG. 2 is a view showing the operating state of the inking unit;

FIG. 3 is a perspective view of the inking unit;

FIG. 4 is a side view of essential parts of a printing unit;

FIG. 5 is a front view of essential parts of a plate cylinder, showing Embodiment 2 of the present invention;

FIG. 6 is a view taken on line A-A in FIG. 5;

FIG. 7 is a side view of a printing press equipped with a movable inking unit, showing Embodiment 3 of the present invention;

FIG. 8 is a side view of essential parts of a printing press equipped with a movable inking unit, showing a conventional example; and

FIG. 9 is a perspective view of the movable inking unit, showing the conventional example.

### DETAILED DESCRIPTION OF THE INVENTION

A printing press equipped with a movable inking unit according to the present invention will now be described in detail by embodiments with reference to the accompanying drawings.

### Embodiment 1

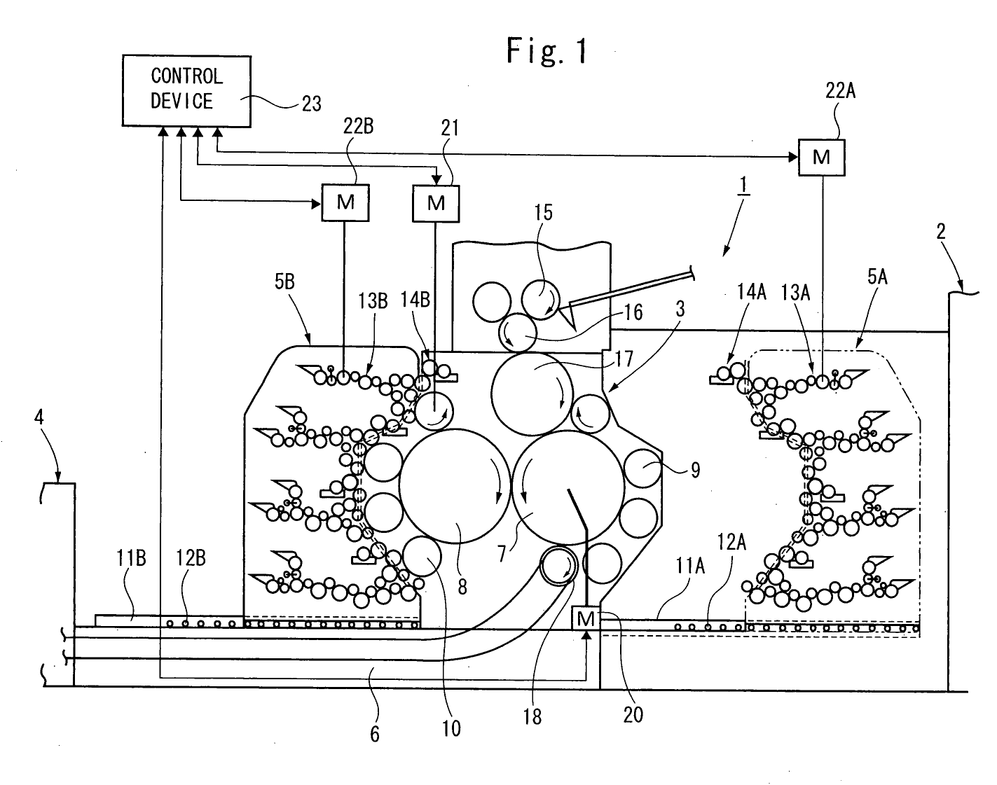

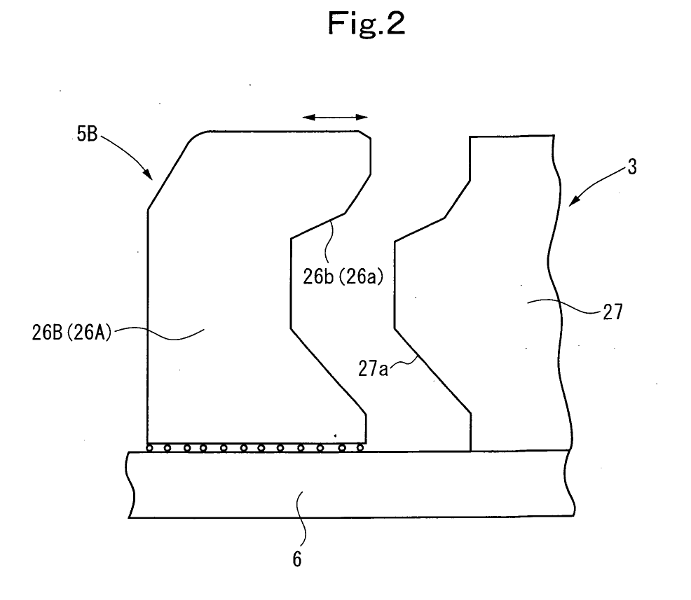

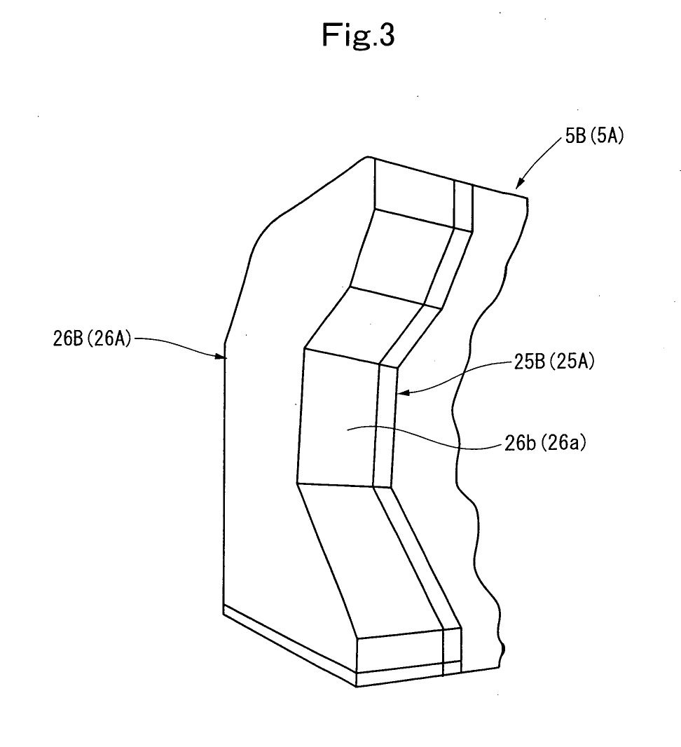

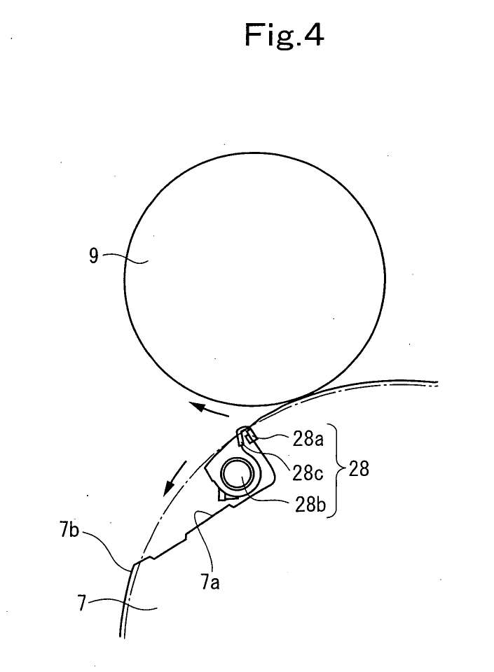

FIG. 1 is a side view of a printing press equipped with a movable inking unit, showing Embodiment 1 of the present invention. FIG. 2 is a view showing the operating state of the inking unit. FIG. 3 is a perspective view of the inking unit. FIG. 4 is a side view of essential parts of a printing unit.

As shown in FIG. 1, a printing press 1 of the present invention comprises a feeder 2, a printing section (hereinafter referred to as a printing unit) 3, a delivery unit 4, a feed side inking unit (hereinafter referred to as a feed side inker) 5A, and a delivery side inking unit (hereinafter referred to as a delivery side inker) 5B. The feeder 2 and the delivery unit 4 are connected together by a pair of (i.e., right and left) beds extending on a floor surface.

In the printing unit 3, a blanketed impression cylinder (opposed cylinder) 7 and a blanket cylinder (opposed cylinder) 8 are journaled in contact with each other. Four plate cylinders 9 and four plate cylinders 10 are arranged in a satellite configuration in contact with the circumferential surfaces of the blanketed impression cylinder 7 and the blanket cylinder 8, respectively.

The feed side inker 5A and the delivery side inker 5B are located on both sides of the printing unit 3, with the printing unit 3 being placed between the inkers 5A and 5B. The inkers 5A and 5B are placed via a plurality of rollers 12A and 12B on rails 11A and 11B laid on the beds 6, 6. The inkers 5A and 5B are moved along the rails 11A and 11B, whereby the inkers 5A and 5B can approach and leave the printing unit 3.

The inkers 5A, 5B have a plurality of inking devices 13A, 13B and a plurality of dampeners 14A, 14B corresponding to the plurality of plate cylinders 9, 10. When the inkers 5A, 5B are moved toward the printing unit 3 and connected to the printing unit 3, their final rollers contact the plate cylinders 9, 10.

Thus, paper (a material to be printed) fed from the feeder 2 is transported along a path shown by arrows in the drawing, namely, along the circumferential surfaces of transfer cylinders 15 to 17, the blanketed impression cylinder 7, and a delivery cylinder 18. When the paper is passed at the point of contact between the blanketed impression cylinder 7 and the blanket cylinder 8 from above toward below, both surfaces of the paper are printed simultaneously.

According to the present embodiment, the cylinders of the printing unit 3, such as the blanketed impression cylinder 7 and the blanket cylinder 8, except the plate cylinders 9 and 10, are rotationally driven by a rotary encoder-equipped motor (first drive source) 20 via a gear mechanism (first drive system; not shown) . On the other hand, the plate cylinders 9, 10 are rotationally driven by a rotary encoder-equipped motor (third drive source) 21 via a gear mechanism (not shown) That is, the plate cylinders 9, 10 are independently driven in the printing unit 3.

The ink rollers and dampening rollers of the inking devices 13A, 13B and the dampeners 14A, 14B in the inkers 5A, 5B are rotationally driven by rotary encoder-equipped motors (second drive source) 22A, 22B via gear mechanisms (second drive system; not shown) . That is, the gear mechanism of the inkers 5A, 5B is completely cut off from the gear mechanism of the printing unit 3.

The motors 20 to 22A, 22B are driven and controlled by a control device 23, such as a microcomputer, in the following manner: At the time of printing when the inkers 5A, 5B are connected to the printing unit 3, the plate cylinders 9, 10 are controlled in synchronism with other cylinders, such as the blanketed impression cylinder 7 and the blanket cylinder 8. The ink rollers and the dampening rollers of the inking devices 13A, 13B and the dampeners 14A, 14B are controlled to be consistent in speed with the plate cylinders 9, 10 and the other cylinders such as the blanketed impression cylinder 7 and the blanket cylinder 8.

At the time of maintenance (cleaning, plate replacement, etc.) when the inkers 5A, 5B are separated from the printing unit 3, on the other hand, the plate cylinders 9, 10 of the printing unit 3, the other cylinders, such as the blanketed impression cylinder 7 and the blanket cylinder 8, and the ink rollers and the dampening rollers of the inking devices 13A, 13B and the dampeners 14A, 14B are independently driven.

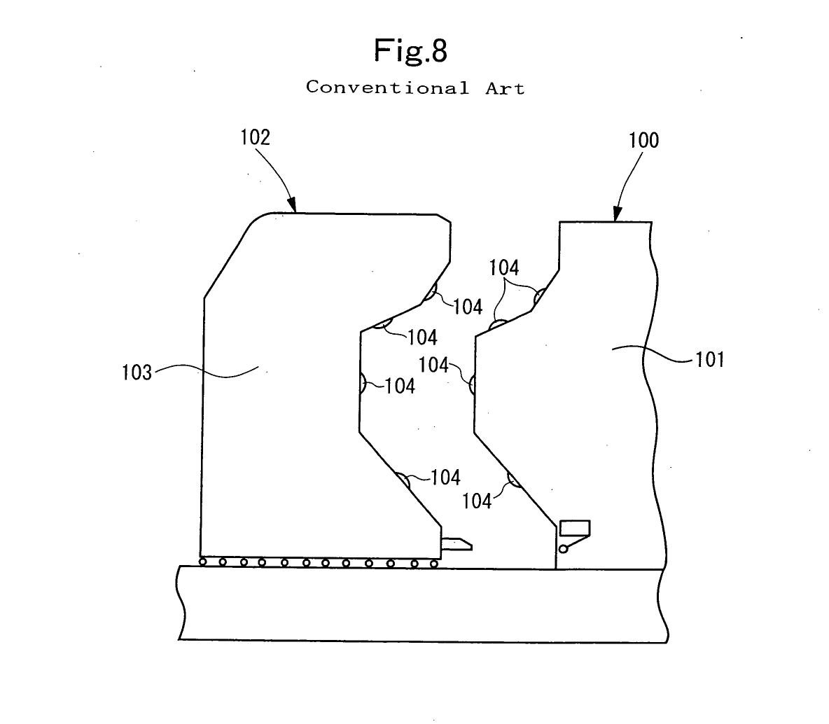

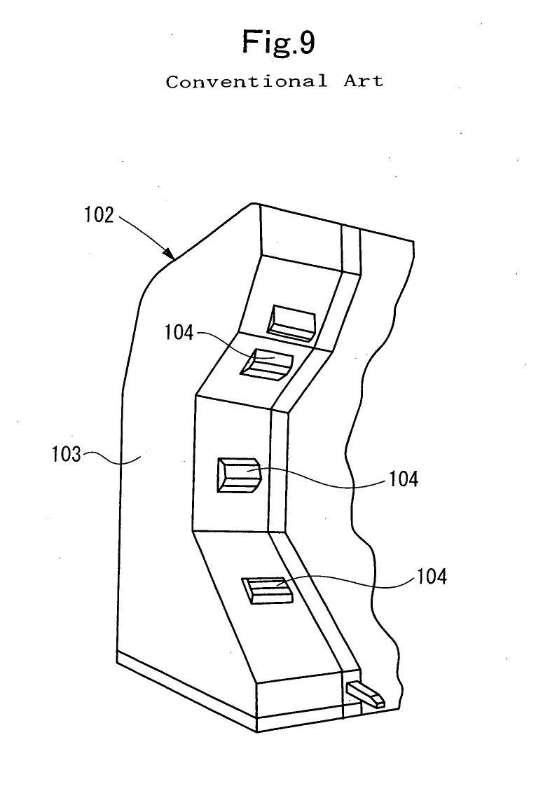

As shown in FIGS. 2 and 3, the gear mechanisms of the inkers 5A, 5B are housed inside frame covers (second covers) 26A, 26B annexed to outer side surfaces of frames 25A, 25B of the inkers 5A, 5B. The gear mechanisms of the printing unit 3 are housed inside a frame cover (first cover) 27 annexed to an outer side surface of a frame (not shown) of the printing unit 3. Opposed surfaces (connecting surfaces) 26a, 26b, 27a of the frame covers 26A, 26B of the inkers 5A, 5B and the frame cover 27 of the printing unit 3 are entirely closed with respect to each other. That is, the plurality of gear engagement windows opened and closed with the protective covers 104, as shown in FIGS. 8 and 9, are not formed.

As shown in FIG. 4, the blanketed impression cylinder 7 for transporting paper in the printing unit 3 has a gripper device 28 in a gap 7a, the gripper device 28 being composed of a gripper pad 28a, a gripper holder 28b, and a gripper 28c. The gripper device 28 is set such that the gripper 28c, which becomes an outermost peripheral portion of the gripper device 28, is located inwardly, in the radial direction of the blanketed impression cylinder 7, of the outer peripheral surface (effective impression area) 7b of the blanketed impression cylinder 7, when the gripper 28c holds the paper 7. In other words, the outer peripheral surface 7b of the blanketed impression cylinder 7 is set to be larger in diameter than the outer peripheral surface of an ordinary blanket cylinder or the like (see a dasheddotted line in the drawing) .

Because of the above-described configuration, the gear mechanism of the plate cylinders 9, 10 in the printing unit 3 is driven by the rotary encoder-equipped motor 21, the gear mechanism of the other cylinders, such as the blanketed impression cylinder 7 and the blanket cylinder 8, is driven by the rotary encoder-equipped motor 20, and the gear mechanisms of the inking devices 13A, 13B and the dampeners 14A, 14B in the inkers 5A, 5B are driven by the rotary encoder-equipped motors 22A, 22B. As noted here, the respective gear mechanisms are driven by dedicated motors.

In the present embodiment, the frame cover 27 accommodating the gear mechanisms of the printing unit 3, and the frame covers 26A, 26B accommodating the gear mechanisms of the inkers 5A, 5B have their opposed surfaces entirely closed, so that oil leakage is reliably prevented. Moreover, no gear engagement takes place between their gear mechanisms. Thus, no wear due to throw-on and throw-off occurs, and there is no need for adjustment of engagement. Consequently, the machine accuracies of the printing unit 3 and the inkers 5A, 5B can be maintained satisfactorily for long periods, and the burden on the operator can be lessened.

If the gear mechanisms of the printing unit 3 and the gear mechanisms of the inkers 5A, 5B are driven independently as described above, the loads on the inkers 5A, 5B are not imposed on the gear mechanisms of the printing unit 3. This causes relative movement between the blanketed impression cylinder 7 and the plate cylinder 9 corresponding to the backlash of the gears in accordance with the throw-on and throw-off between the gap 7a of the blanketed impression cylinder 7 transporting the paper and the plate cylinder 11. 9 opposing the gap 7a. As a result, a printing trouble, such as doubling, breaks out.

According to the present embodiment, therefore, the gear mechanism of the plate cylinders 9, 10 is driven by the rotary encoder-equipped motor 21 independently of the gear mechanism of the other cylinders such as the blanketed impression cylinder 7 and the blanket cylinder 8, as stated earlier. By so doing, relative movement between the blanketed impression cylinder 7 and the plate cylinder 9 is avoided.

If the plate cylinders 9, 10 are driven by the dedicated rotary encoder-equipped motor 21, as mentioned above, the problem arises that the rotation phases of the plate cylinder 9 and the blanketed impression cylinder 7 are shifted with respect to each other during emergency shutdown of the printing press 1. As a result, the gripper 28c of the blanketed impression cylinder 7 interferes with the circumferential surface of the plate cylinder 9 or the plate mounted on the plate cylinder 9, thereby damaging or injuring it.

According to the present embodiment, therefore, the gripper 28c constituting the outermost peripheral portion of the gripper device 28 in the blanketed impression cylinder 7 is set to be located inwardly, in the radial direction of the blanketed impression cylinder 7, of the outer peripheral surface (effective impression area) 7b of the blanketed impression cylinder 7, as described earlier. By this measure, the gripper 28c of the blanketed impression cylinder 7 is prevented from interfering with the circumferential surface of the plate cylinder 9 or the plate mounted on the plate cylinder 9.

In the present embodiment, the plate cylinders 9, 10 are driven collectively by the single motor 21 having the rotary encoder. However, the plate cylinders 9 opposing the blanketed impression cylinder 7 may be driven by a motor, and the plate cylinders 10 opposing the blanket cylinder 8 may be driven by another motor.

### Embodiment 2

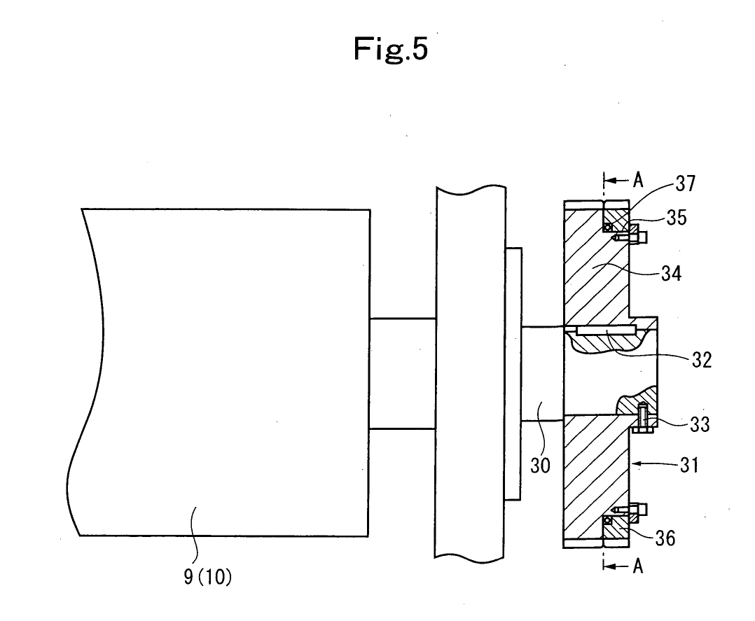

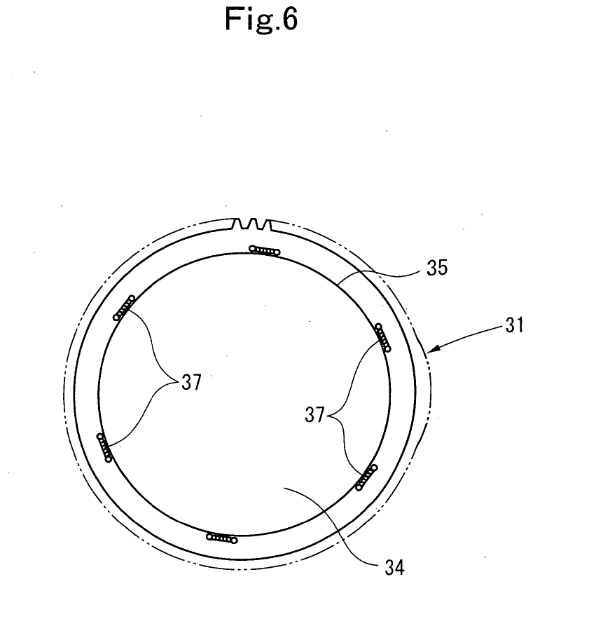

FIG. 5 is a front view of essential parts of the plate cylinder, showing Embodiment 2 of the present invention. FIG. 6 is a view taken. on line A-A in FIG. 5.

This is an embodiment in which the independent driving of the plate cylinders. 9, 10 by the motor in Embodiment is not performed; an anti-backlash gear 31 involving no backlash (without so-called play) is used as a gear fixed to a shaft 30 of the plate cylinder 9 or 10 for rotationally driving the plate cylinder 9 or 10; and this gear 31 is linked to the gear mechanism of the other cylinders, such as the blanketed impression cylinder 7 and the blanket cylinder 8, and is rotationally driven by the rotary encoder-equipp motor 20. Other features are the same as those in Embodiment 1.

The anti-backlash gear 31 has a first gear 34 fixed to the shaft 30 of the plate cylinder 9 or 10 by a key 32 and a bolt 33; a second gear 36 fitted onto an outer peripheral step portion 35 of the first gear 34 to be relatively rotatable and unremovable by twisting, the second gear 36 having the same number of gear teeth as that of the first gear 34; and a plurality of (six in the illustrated example) elastic members 37 arranged at equal intervals in the circumferential direction and having one end supported by the first gear 34 and the other end supported by the second gear 36. In the anti-backlash gear 31, the second gear 36, urged by the elastic members 37, always follows a spur gear engaging the first and second gears 34 and 36, whereby backlash is eliminated.

According to the present embodiment, the gear mechanisms of the printing unit 3 and the gear mechanisms of the inkers 5A, 5B are driven independently, whereby the same actions and effects as those in Embodiment 1 are obtained. In addition, the relative movement between the blanketed impression cylinder 7 and the plate cylinder 9, which is generated by independently driving the gear mechanisms of the printing unit 3 and the gear mechanisms of the inkers 5A, 5B, can be effectively avoided by the anti-backlash gear 31. Thus, a printing trouble, such as doubling, can be prevented.

In the present embodiment, a tension spring or a compression spring is generally used as the elastic member 37. In the present embodiment, moreover, there is no shift in rotation phase between the plate cylinder 9 and the blanketed impression cylinder 7 even during emergency shutdown, unlike Embodiment 1. Thus, there is no need to set the outermost peripheral portion of the gripper device 28 of the blanketed impression cylinder 7 to be inward, in the radial direction of the blanketed impression cylinder 7, of the outer peripheral surface 7b of the blanketed impression cylinder 7, as in Embodiment 1.

### Embodiment 3

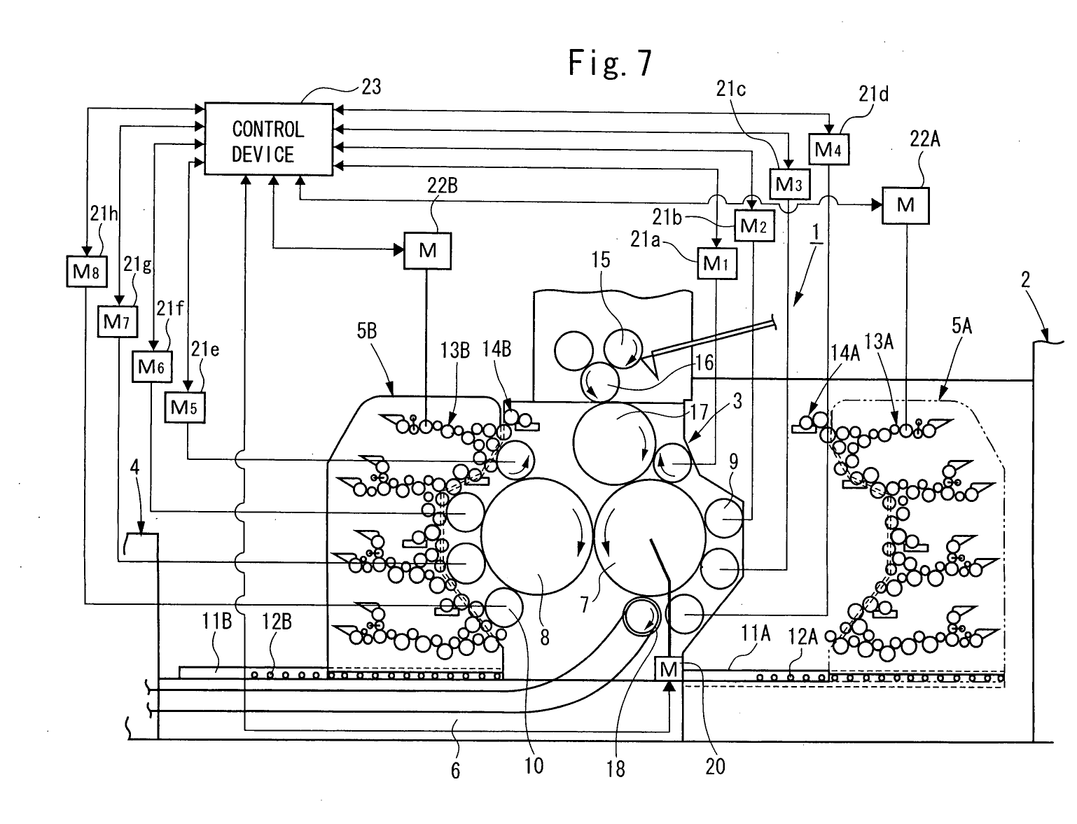

FIG. 7 is a side view of a printing press equipped with a movable inking unit, showing Embodiment 3 of the present invention.

This is an embodiment in which instead of driving the plate cylinders 9, 10 by the single motor 21, motors 21a to 21h having rotary encoders are provided for the respective plate cylinders 9, 10 to drive the eight plate cylinders 9, 10 directly by the eight motors 21a to 21h. Since other features are the same as those in Embodiment 1, the same members as those in FIG. 1 are assigned the same numerals as those in FIG. 1, and duplicate explanations are omitted.

In the present embodiment as well, the same actions and effects as those in Embodiment 1 are obtained.

The invention thus described, it will be obvious that the same may be varied in many ways. For example, the use of one motor 22A (22B) for rotationally driving the inking devices 13A (13B) of the inker 5A (5B) is disclosed in the above-described embodiments. However, there may be provided motors whose number corresponds to the number of colors of the inking devices. Such variations are not to be regarded as a departure from the spirit and scope of the invention, and all such modifications as would be obvious to one skilled in the art are intended to be included within the scope of the following claims.

1. A printing press equipped with a movable inking unit, comprising:
a printing unit;
a first drive source for driving said printing unit;
a first drive system for drivingly connecting cylinders of said printing unit to said first drive source;
a first cover for covering said first drive system;
said movable inking unit movable to be capable of being thrown on and thrown off said printing unit;
a second drive system for driving ink rollers of said movable inking unit;
a second cover for covering said second drive system; and
a second drive source for driving said ink rollers of said movable inking unit via said second drive system,
wherein a surface of said first cover opposing said second cover is entirely closed, and a surface of said second cover opposing said first cover is entirely closed.

2. The printing press equipped with a movable inking unit according to claim l, wherein
said first drive source and said second drive source are motors driven and controlled by a control device such that a speed of said cylinders of said printing unit and a speed of said ink rollers are equal to each other.

3. The printing press equipped with a movable inking unit according to claim 1, wherein
said printing unit is composed of a plate cylinder, and an opposed cylinder opposing said plate cylinder, and
said printing press further comprises a third drive source for driving said plate cylinder.

4. The printing press equipped with a movable inking unit according to claim 3, wherein
said third drive source is a motor driven and controlled by a control device such that said plate cylinder and said opposed cylinder are synchronized with each other.

5. The printing press equipped with a movable inking unit according to claim 3, wherein
said opposed cylinder has a gripper device for transporting a material to be printed, and
when said gripper device holds said material to be printed, an outermost peripheral portion of said gripper device is located inwardly, in a radial direction of said opposed cylinder, of an outer peripheral surface of said opposed cylinder.

6. The printing press equipped with a movable inking unit according to claim 1, wherein
said printing unit is composed of a plate cylinder, and an opposed cylinder opposing said plate cylinders and
a gear fixed to a shaft of said plate cylinder for rotationally driving said plate cylinder is an anti-backlash gear.

7. The printing press equipped with a movable inking unit according to claim 6, wherein
said anti-backlash gear has a first gear fixed to said shaft of said plate cylinder, a second gear adjacent to said first gear to be relatively rotatable and having an identical number of teeth to a number of teeth of said first gear, and a plurality of elastic members arranged at equal intervals in a circumferential direction and having one end supported by said first gear and another end supported by said second gear.
